(19) United States
(12) Patent Application Publication
(10) Pub. No.: US 2024/0080392 A1
(43) Pub. Date: Mar. 7, 2024

(54) LINK GENERATION FOR RAN PARSER

(71) Applicant: EXFO Solutions SAS, Saint-Jacques de la Lande (FR)

(72) Inventors: Angel DURÁN ALCAIDE, Pontevedra (ES); Juan José RUBIO ESTEBAN, València (ES); Maria Amparo NAVARRO PERIS, València (ES); Rubén ROSELL SABORIT, Castellón (ES)

(21) Appl. No.: 18/459,830

(22) Filed: Sep. 1, 2023

Related U.S. Application Data
(60) Provisional application No. 63/441,663, filed on Jan. 27, 2023.
(60) Provisional application No. 63/404,438, filed on Sep. 7, 2022.

(51) Int. Cl. H04M 15/00; H04M 3/22; H04W 4/24

(52) U.S. Cl. CPC H04M 15/41; H04M 3/2218; H04W 4/24

(57) ABSTRACT

A method includes accessing messages stored in a publishing system, wherein the messages are derived from Call Trace messages and are stored in a vendor and technology agnostic manner; starting a cell fragment based on a starting type message for a call; linking associated messages for the call to the cell fragment; ending the cell fragment based on an ending type message for the call; and utilizing the cell fragment for creating a Call Data Record (CDR) of the call.

### CROSS-REFERENCE TO RELATED APPLICATION(S)

The present disclosure claims priority to U.S. Provisional Patent Application No. 63/441,663, filed Jan. 27, 2023, and U.S. Provisional Patent Application No. 63/404,438, filed Sep. 7, 2022, the contents of each are incorporated by reference in their entirety.

### FIELD OF THE DISCLOSURE

The present disclosure relates generally to networking and computing. More particularly, the present disclosure relates to systems and methods for link generation for a Radio Access Network (RAN) parser that links messages from different interfaces into cell fragments.

### BACKGROUND OF THE DISCLOSURE

In a telecommunications network, there are solutions for planning, troubleshooting and optimizing mobile networks using dynamic, geo-located devices, and subscriber data. A RAN Data Processing System (also referred to herein as a Parser, a RAN parser, and a parsing agent) is a scalable software adapter which collects and processes 2G, 3G, 4G and 5G 3rd Generation Partnership Project (3GPP) and vendor-specific RAN call events to generate call records and, optionally geolocated call records and real time location insights.

The main output of RAN parser is a RAN user call data record (CDR) based on the messages provided by the network. This requires a correlation between different sources and messages found in the customer's information. And the aim is to provide the CDR as soon as the call in the network has finished.

### BRIEF SUMMARY OF THE DISCLOSURE

The present disclosure relates to systems and methods for link generation for a Radio Access Network (RAN) parser that links messages from different interfaces into cell fragments. The present disclosure provides a technique to link messages from different interfaces into cell fragments. The linkage between messages (link together all messages pertaining to the same user call) is crucial in the behavior of the parsers to reproduce the calls happening in the network and then to extract and summarize the information at call level that is relevant to the customers. A method includes accessing messages stored in a publishing system, wherein the messages are derived from Call Trace messages and are stored in a vendor and technology agnostic manner; starting a cell fragment based on a starting type message for a call; linking associated messages for the call to the cell fragment; ending the cell fragment based on an ending type message for the call; and utilizing the cell fragment for creating a Call Data Record (CDR) of the call.

In various embodiments, the present disclosure can include a method having steps, a processing device configured to implement the steps, and a non-transitory computer-readable medium storing instructions for programming one or more processors to implement the steps. The steps include accessing messages stored in a publishing system, wherein the messages are derived from Call Trace messages and are stored in a vendor and technology agnostic manner; starting a cell fragment based on a starting type message for a call; linking associated messages for the call to the cell fragment; ending the cell fragment based on an ending type message for the call; and utilizing the cell fragment for creating a Call Data Record (CDR) of the call.

The publishing system can be configured to receive the messages at an edge of a mobile network. The linking can be based on fragment identifiers in the messages. The linking for messages that do not have the fragment identifiers can be based on using standard fields from other messages already linked in the cell fragment. The other messages can be any of an RRC Connection Request, RRC Connection Request-NB, X2AP Handover Request, S1AP Handover Request, RRC Connection Reestablishment Request, X2AP Handover Report, X2AP RLF Indication, S1AP Reset, and S1AP Reset Acknowledge. The steps can further include enriching the cell fragment with user identities for the call. The user identities can include one or more of International Mobile Subscriber Identity (IMSI) and International Mobile Equipment Identity (IMEI). The call can be in one of three different states including started, established, and ended, and wherein the linking is based on which state the call is in.

### BRIEF DESCRIPTION OF THE DRAWINGS

The present disclosure is illustrated and described herein with reference to the various drawings, in which like reference numbers are used to denote like system components/method steps, as appropriate, and in which:

FIG. 1 is a block diagram of architecture of a Link Generation Service.

FIG. 2 is a message flow diagram of a RRC Connection Request between a UE and an eNB.

FIG. 3 is a message flow diagram of a X2AP Handover Request between a source eNB and a target eNB.

FIG. 4 is a message flow diagram of a S1AP Handover Request message flow between the target eNB and an MME.

FIG. 5 is a message flow diagram of an RRC Connection Reestablishment Request message flow between the UE and the eNB.

FIG. 6 is a message flow diagram of an X2AP Handover Report message flow between the source eNB and the target eNB.

FIG. 7 is a message flow diagram of an X2AP RLF Indication message flow between the source eNB and the target eNB.

FIG. 8 is a message flow diagram of a RRC Connection Request-NB between a UE and an eNB.

FIGS. 9-14 are flowcharts of various processes associated with the Link Generation Service. FIG. 9 is a Link Generation process. FIG. 10 illustrates how to link messages without fragmentID1 and fragmentID2 to a fragment. FIG. 11 illustrates how to link messages with the fragmentID1 and the fragmentID2 to a fragment. FIG. 12 illustrates how to process S1AP Reset messages. FIG. 13 illustrates how to store unlinked EUTRA-RRC RRC Connection Request messages. FIG. 14 illustrates how to retrieve unlinked messages.

FIG. 15 is a flowchart of a process for link generation for a Radio Access Network (RAN) parser that links messages from different interfaces into cell fragments.

FIG. 16 is a block diagram of a processing system, which may be used to implement the process.

### DETAILED DESCRIPTION OF THE DISCLOSURE

Again, the present disclosure relates to systems and methods for link generation for a Radio Access Network (RAN) parser that links messages from different interfaces into cell fragments. The purpose of the current Parsers (non-cloud native) is to be able to regenerate a RAN user call based on the messages provided by the network. There is a correlation between different sources and messages, and this information is targeted as soon as the call in the network has finished. Apart from the “call details” output (CDR), the parser is able to provide other processed outputs, such as the geolocation (GDR) of the user along the call in Near Real Time (NRT) or specific Key Performance Indicators (KPIs) that allow optimization algorithms and recommendations to the network operator about which should be changed in the RAN network configuration to improve its quality. Parsers receive information provided by the customer network elements by files or by TCP streams (natively only in the Cloud Parser architecture). The supported formats depend on the vendor and technology; therefore, the Parsers should be able to understand, process and provide the corresponding outputs independently of the vendor/technology specificities.

The present disclosure includes a Cloud Native Parser that reproduces the behavior of the current Parsers via a new architecture that requires changes in terms of how the information is processed how it is distributed along the different elements, how it is generated and how it is sent out of the system. The Cloud Native Parser aims to replace the legacy architecture making it more flexible and able to be deployed in several pieces along different locations (edge, central, etc. in a customer network in front of the monolithic version where only the central site deployment was allowed.

### RAN Parser

RAN parsers require Call Traces (CTs) as inputs. CTs are generated by Network Elements (NEs) from the client's mobile network and have a vendor proprietary format depending on
the vendor itself: e.g., Huawei, Nokia, Ericsson, Samsung, ZTE . . . .
the technology of the mobile network: 2G, 3G, 4G, 5G, etc.
the trace format: e.g., there are Huawei 4G traces in format “TRC” and Huawei 4G traces in format STDSIG, and not only the format changes but also the content (there is information present in one but not in the other and vice versa)
the trace release: there can be internal changes between vendor release X.1 and vendor release X.2 of a certain trace format (changes in existent information, addition of new information, deprecation of existent information).

### Link Generation Service

Input messages to a Parser need to be linked to a certain call, even if standard information necessary to do that is not present in the message itself. The present disclosure includes a Link Generation Service for the Parser that is configured to link messages. The Link Generation service has the following characteristics:
it can be deployed at the edge instead of in a centralized monolithic location
The linking of messages to a certain call is vendor/technology agnostic
We are able to link messages to a call, even when the standard information to do that is not present
Load Balancing performed by Network element based on information received in the messages

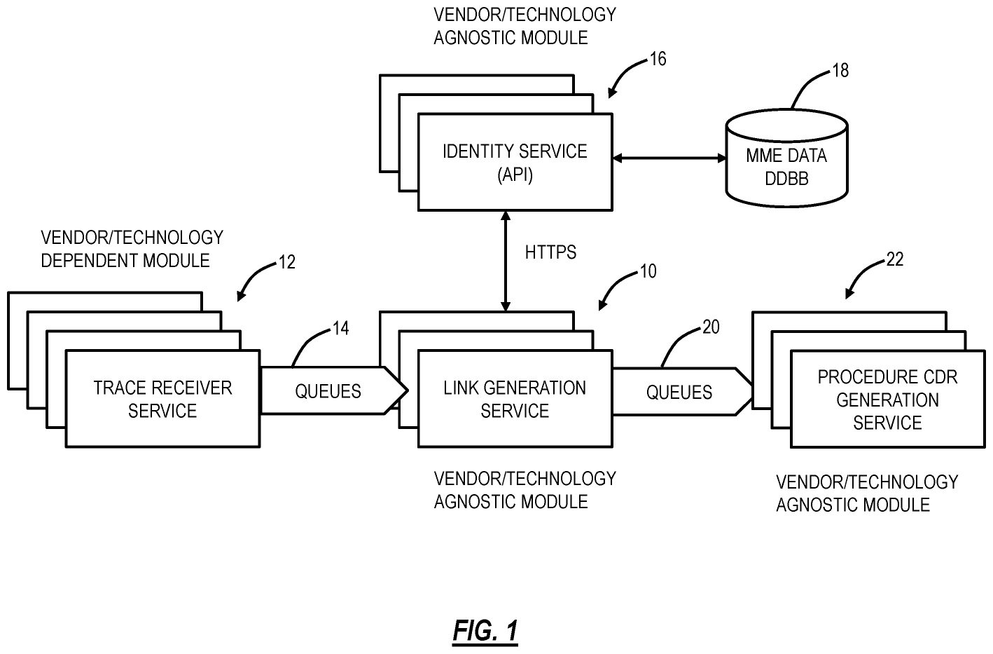

FIG. 1 is a block diagram of architecture of a Link Generation Service 10. Input information for the Link Generation Service 10 is the output information generated by a Trace Receiver Service 12 in vendor/technology agnostic format, allowing to keep independent of the vendor and technology all the elements after it in the microservices pipeline. Therefore, the Link Generation Service 10 can be considered as a vendor/technology agnostic module itself. The Trace Receiver Service 12 is configured to receive technology-specific and/or vendor-specific Call Trace messages and output data in a shared common output format that is the same regardless of vendor and/or technology.

A linkage between messages (link together all messages pertaining to the same user call) is crucial in the behavior of the parsers to reproduce the calls happening in the network and then to extract and summarize the information at call level that is relevant to the customers. The input format is described as follows. Those skilled in the art will appreciate this is merely illustrative and practical embodiments may include other vendors, technologies, new vendors, technology, etc.

TABLE 1
Input of Link Generation Service

| Field | Type | Description |
|---|---|---|
| timestamp_utc_ms | int64 | Timestamp of the message in milliseconds |
| time_zone_correction | int32 | Time zone correction |
| timestamp_dst_cor | int32 | Day Light Save Time Correction |
| technology | int32 | Technology |
| vendor | int32 | Vendor |
| version | int32 | Version |
| mcc | string | Mobile Country Code of the subscriber network |
| | | (3 digits) |
| mnc | string | Mobile Network Code of the subscriber network |
| | | (2 o 3 digits) |
| fragment_id_1 | int64 | First Identifier of the Unique Session Id for User |
| | | Equipment (UE) |
| fragment_id_2 | int64 | Second Identifier of the Unique Session Id for the UE |
| enb_id | int64 | eNode B Id or gNode B Id depending on technology |
| cell_id | int32 | Cell Id |
| core_ue_id | int64 | mme_ue_s1ap_id or amf_ue_ngap_id depending on |
| | | the technology. Uniquely identifies the UE |
| | | association over the S1 interface within the MME or |
| | | NG interface within the AMF |
| ran_ue_id | int64 | enb_ue_s1ap_id or ran_ue_ngap_id depending on |
| | | the technology. Uniquely identifies the UE |
| | | association over the S1 interface within a eNB or NG |
| | | interface within an gNB |
| gummei | int64 | gummei or guami depending on the technology. |
| | | Unique identifier of a MME or an AMF |
| c_rnti | int32 | C-RNTI Identifier |
| message_type | int32 | enumerated to identify the same message from |
| | | different vendors |
| message_direction | int32 | Message direction: sent, received |
| message_content | bytes | asn.1 content for 3GPP messages, raw data for |
| | | messages |
| gnodeb_id_length | int32 | Number of bits used to encode gNodeB Id |

The Link Generation Service 10 receives vendor/technology agnostic from the Trace Receiver Service 12 via queues 14, communicates via Hypertext Transfer Protocol Secure (HTTPS) to an Identity Service 16 which communicates with a database 18, and provides output, via queues 20, to a CDR Procedure Generation Service 22. Note, in an embodiment, the system can be implemented in Apache Kafka. In the Apache Kafka Queueing system, messages are saved in a queue fashion. This allows messages in the queue to be ingested by one or more consumers, but one consumer can only consume each message at a time. The Queue topic in the Apache Kafka Queue will contain the messages to be processed. Apache Kafka is an example of a publishing system.

### Processing

The main functionalities of the Link Generation Service 10 performed with that input information are described as follows.

### Classification of Messages in Calls

Messages are linked to a UE (User Equipment) session using fragment Id 1 and fragment Id 2 identifiers. These identifiers are unique at a given time but can be repeated over time. The Parser aims to create fast outputs, breaks down a UE session or ‘call’ into ‘cell fragments’, separating in different outputs the part of the connection under each serving cell. In this document, the word “call” is used interchangeably with “cell fragment of a call”. When we create a call, we assign a unique identifier (cCDRID ‘cell Call Data Record Identifier’) as follows:
Source Id (string): edge_id++last 5 characters of POD_NAME
Cell Fragment Id (8 bytes): auto incremental value (starting from 0)

To create the calls correctly and not join messages randomly, there are several considerations to take into account:
calls are categorized based on start type. A call can only have one start type
only a limited set of messages can start a call: depending on the message that starts the call, the algorithm selects the start type
calls during processing could be in 3 different states: started, established, or ended. This call state determines how the messages are processed
calls can be ended by 2 reasons:
   network identifier exhaustion. Identifier is repeated within the network
   timeout: depending on call state, the algorithm will wait a variable amount of time to decide that new messages belonging to a call will not be received and therefore sets its state to ‘ended’
when the algorithm makes the decision of ending a call, a message is created that is used by the following modules to complete the call processing

### International Mobile Subscriber Identity (IMSI)—International Mobile Equipment Identity (IMEI) Enrichment by Means of Network Identifiers

In 2G and 3G the Call Trace information contained both the events happening during the call and the user identities (IMSI for user and IMEI for device) of the user performing the call. Since 4G onwards (4G and 5G for now), user identities are encrypted and are retrieved from a separate source of information.

When a Call Trace message containing Mobility Management Entity (MME) UE S1AP (S1 Application Protocol) Id—evolved Node B (eNB) UE S1AP Id identifiers arrives (only certain messages contain them), the Link Generation Service 10 asks the Identity Service 16 for the user identifiers (IMSI/Subscription Concealed Identifier (SUCI)-IMEI). They are stored in a database 18 that can only be accessed through the Identity Service 16, and contains entries relating MME UE S1AP Id—eNB UE S1AP Id to user identifiers and timestamps (the S1AP Id's are re-used continuously by the network therefore they relate to a user only for a certain period of time). The same logic is applicable for 5G messages. In this case MME UE S1AP Id is called AMF UE S1AP Id and eNB UE S1AP is called RAN UE NGAP Id in 5G. In this document, “MME UE S1AP Id” is used interchangeably with “AMF UE S1AP Id” or “Core UE Id” and “ENB UE S1AP Id” is used interchangeably with “RAN UE Id” or “RAN UE NGAP Id”.

Therefore, the Link Generation request uses as keys:
MME UE S1AP Id-eNB UE S1AP Id identifiers
a truncated timestamp: truncation of the timestamp can be setup to different values (5 minutes, 1 minute . . . ). Timestamps in the identity database 18 are also stored in truncated time buckets

And obtains as result the user identifiers specifically related to the message being processed:
IMSI/SUCI
IMEI

To improve performance:
requests can be done for a batch of messages, for example those inside the configurable period of sampling time (e.g., 2500 ms)
request can also consider the synchronization with the identity database 18. The Identity Service 16 provides the Link Generation Service 10 with synchronization information that allows the Link Generation Service 10 to know if data is already available in the identity database 18. If it is not, the Link Generation Service 10 keeps in memory the messages for a while. After a certain period, if data is still not present then the information about user identifiers cannot be retrieved.
only those keys that can be potentially resolved are sent by the Link Generation Service 10 to the Identity Service 16
if any information is found for a certain message on a certain call, the Link Generation Service 10 avoids requesting it again for every message belonging to the same call, that is, from that moment on, user identifiers enrichment is applied to all subsequent messages of the same call based on the local cache.
   Link UE Messages without Fragment Id 1 and/or Fragment Id 2 to a Cell Fragment

An approach to linking uses Fragment Id 1 and Fragment Id 2 to attach the messages to a call. All the searches are made inside the same Network Element, this means they have the same:
Technology
Vendor
MCC
MNC
eNB Id

In an embodiment, the fragment_id_1 and fragment_id_2 are calculated fields based on vendor/technology dependent information contained in the Call Trace 14. They allow services in the pipeline to continue processing information without being vendor aware. The following is an example of calculation for some of the vendors in 4G and 5G. Again, those skilled in the art will appreciate this is merely illustrative and practical embodiments may include other vendors, technologies, new vendors, technology, etc.

TABLE
Example of calculation of Fragment Id1 & Fragment
Id2 for some vendors in LTE (4G) and NR (5G)

| | Fragment Id 1 | Fragment Id 2 |
|---|---|---|
| Ericsson LTE | Global Cell Id - Radio | Trace Recording Session Reference |
| | Access Controller (RAC) | |
| | UE Ref | |
| Huawei LTE | eNodeB Id - Cell Id - CRNTI | Call Id |
| Nokia LTE | eNodeB Id - Cell Id | Evolved-UMTS Terrestrial Radio Access |
| | | Network (EUTRAN) Trace ID |
| Samsung LTE | eNodeB Id - Cell Id | Public Land Mobile Network (PLMN) Id - |
| | | Trace Id - Trace Recording Session |
| | | Reference |
| Huawei New | gNodeB Id - Cell Id | Call Id |
| Radio (NR) | | |
| Samsung NR | gNodeB Id - Cell Id | PLMN Id - Trace Id - Trace Recording |
| | | Session Reference |

But there are some messages that do not have fragment id 1 and/or fragment id 2, so they cannot be attached to a call using this approach. For each of these messages, a special type of linking process is made using standard fields from other messages already linked to the call (in addition to Network Element identifier).

These other messages can include a Radio Resource Control (RRC) Connection Request, a RRC Connection Request-NB, an X2AP Handover Request (eNB target), an S1AP Handover Request, an RRC Connection Reestablishment Request, an X2AP Handover Request, an X2AP Radio Link Failure (RLF) Indication, an S1AP Reset, S1AP Reset Acknowledge, and the like. The following describes using standard fields from these other messages, according to some embodiments.

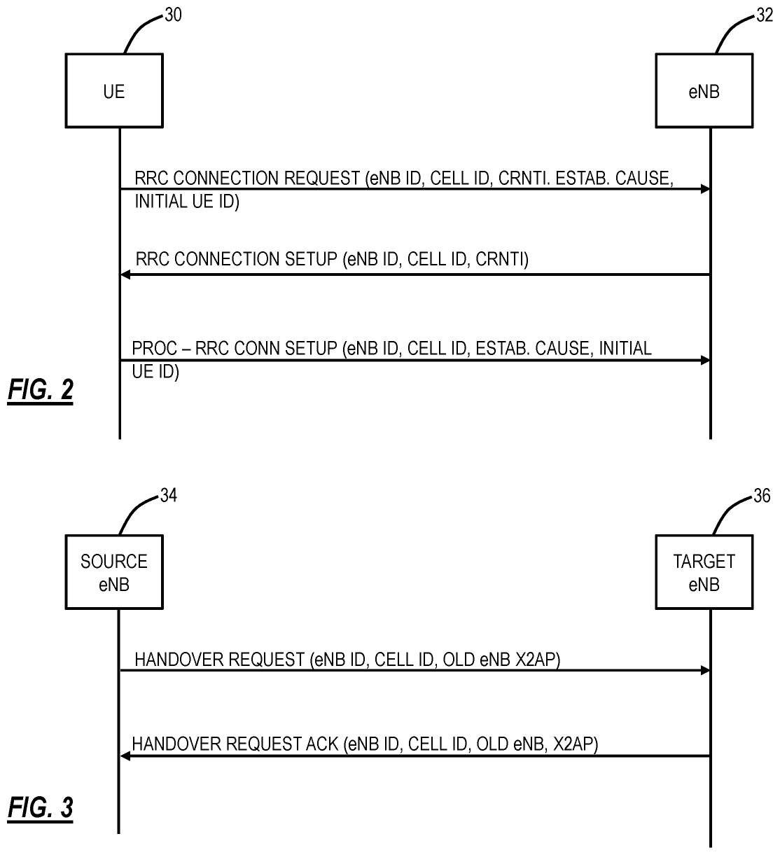

FIG. 2 is a message flow diagram of a RRC Connection Request between a UE 30 and an eNB 32. The UE 30 sends an RRC Connection Request to the eNB 32, the eNB 32 responds with an RRC Connection Setup, and the UE 30 sends a Proc RRC Conn Setup message to the eNB 32. Of note, message fields include various information, as shown in FIG. 2, including message fields “Estab. Cause” and “Initial UE Identity” which can be decoded from these messages. The maximum time between RRC Connection Request and Proc RRC Conn Setup messages should be 30 seconds. To link this message, we use a multimap with key:

<<crnti, cellid>, <initialUeIdentity, rrcEstabCause>>

FIG. 3 is a message flow diagram of a X2AP Handover Request between a source eNB 34 and a target eNB 36. The source eNB 34 sends a Handover Request to the target eNB 36 which responds with a Handover Request Acknowledgement. Of note, message fields include various information, as shown in FIG. 3, including message field of “Old eNB X2AP” which can be decoded from these messages. Instead of Handover Request Acknowledge, Handover Preparation Failure or Handover Cancel messages can be used. To link this message, we use a map with key:

<cellid, Old eNB X2AP>

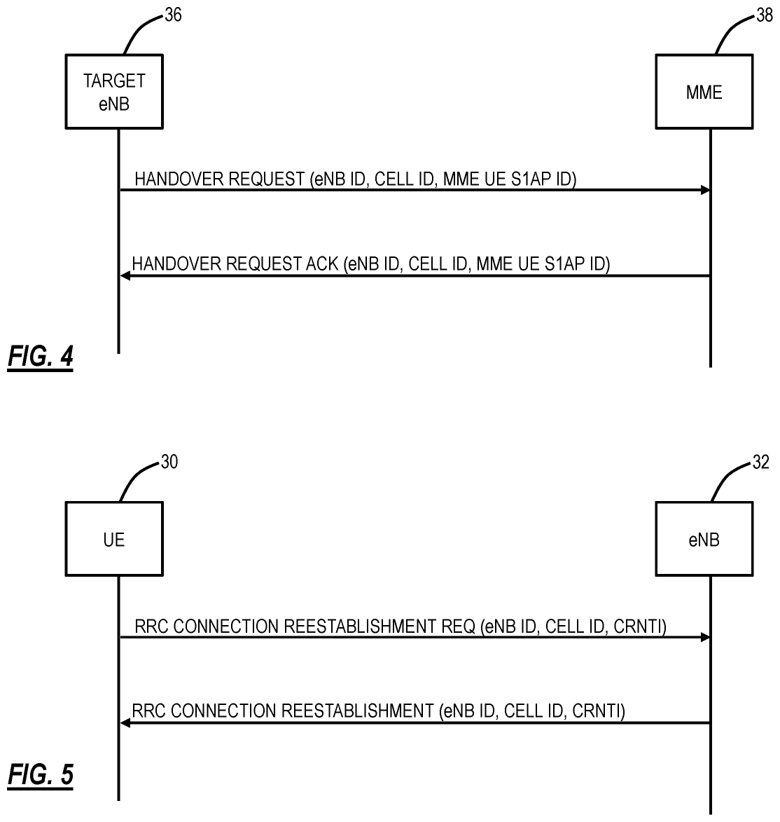

FIG. 4 is a message flow diagram of a S1AP Handover Request message flow between the target eNB 36 and an MME 38. The target eNB 36 sends a Handover Request to the MME 38, and the MME 38 responds with a Handover Request Acknowledgment. Instead of a Handover Request Acknowledge, a Handover Failure message can be used. Of note, message fields include various information, as shown in FIG. 4. We use the header fields, and to link this message, we use a map with key:

<cellid, mme_ue_s1ap_id>

FIG. 5 is a message flow diagram of an RRC Connection Reestablishment Request message flow between the UE 30 and the eNB 32. The UE 30 sends a RRC Connection Reestablishment Request message to the eNB 32, and the eNB 32 responds with an RRC Connection Reestablishment message to the UE 30. Of note, message fields include various information, as shown in FIG. 5. “CRNTI” is an optional field, only used when it is possible. To link this message we can use 2 different maps:

<cellid, crnti>
and
<cellid, fragmentId2>

When the message RRC Connection Reestablishment Request arrives, depending on fragmentId2 field being available or not, the message will be stored in the fragmentId2 map or in the crnti. When RRC Connection Reestablishment or RRC Connection Reject arrives, they will find the RRC Connection Reestablishment Request by crnti and in case of failure, they will try again by fragmentId2. The maximum time between RRC Connection Reestablishment Request and RRC Connection Reestablishment messages should be 350 milliseconds.

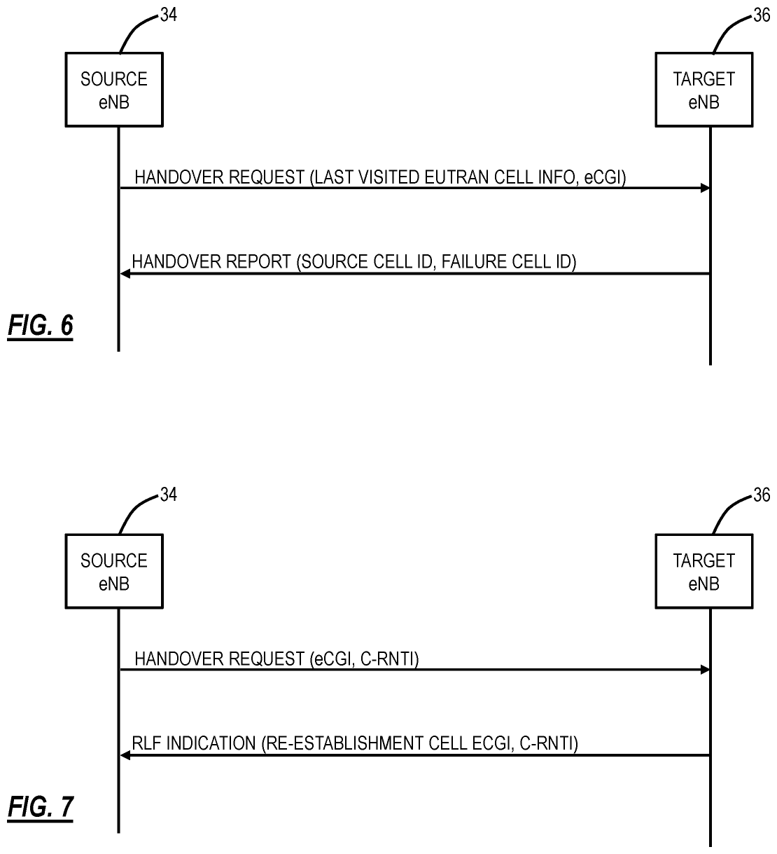

FIG. 6 is a message flow diagram of an X2AP Handover Report message flow between the source eNB 34 and the target eNB 36. The source eNB 34 sends a Handover Request message to the target eNB 36, and the target eNB 36 responds with a Handover Report message. Of note, message fields include various information, as shown in FIG. 6. Fields “Last Visited EUTRAN cell information”, “eCGI”, “source cell Id” and “failure cell Id” have to be decoded in this module. To link this message, we use a map with key:

<sourceCellid, failureCellId>

FIG. 7 is a message flow diagram of an X2AP RLF Indication message flow between the source eNB 34 and the target eNB 36. The source eNB 34 sends a Handover Request message to the target eNB 36, and the target eNB 36 responds with RLF Indication message. Of note, message fields include various information, as shown in FIG. 7. Fields “Re-establishment Cell Id”, “eCGI”, “C-RNTI” and “failure cell Id” have to be decoded in this module. To link this message, we use a map with key:

<reEstablishmentCellid, crnti>

For S1AP Reset and S1AP Reset Acknowledge messages (the same logic is applicable to the NGAP Reset and NGAP Reset Acknowledge messages), for these pair of messages, we have 3 scenarios:
CASE 1: Reset message with empty UE-associated logical S1-connection Item IEs. Reset message is linked to all fragments of the same eNB (Vendor, Technology, MCC-MNC, eNodeB Id).
CASE 2: UE-associated logical S1-connection Item IEs have only MME UE S1AP Id or eNB UE S1AP Id. Reset message is linked to all fragments with the same eNB (Vendor, Technology, MCC-MNC, eNodeB Id).
CASE 3: UE-associated logical S1-connection Item IEs have MME UE S1AP Id and eNB UE S1AP Id. Reset message is linked to all fragments with the same identifiers MME UE S1AP Id, eNB UE S1AP Id in the same eNB (Vendor, Technology, MCC-MNC, eNodeB Id).

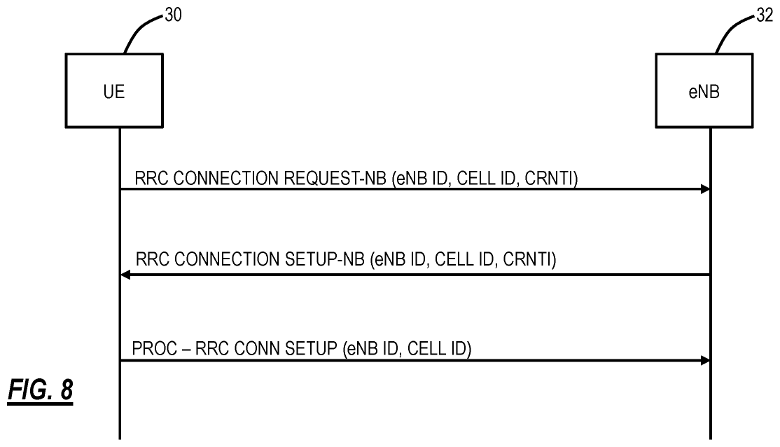

FIG. 8 is a message flow diagram of a RRC Connection Request-NB between a UE 30 and an eNB 32. The UE 30 sends an RRC Connection Request-NB to the eNB 32, the eNB 32 responds with an RRC Connection Setup-NB, and the UE 30 sends a Proc RRC Conn Setup message to the eNB 32. The maximum time between RRC Connection Request-NB and Proc RRC Conn Setup messages should be 30 seconds. To link this message, we use a multimap with key:

<crnti, cellid>

Enrichment of Some Fields

A subset of fields of interest that could not be fulfilled during the processing performed by the Trace Receiver Service 12 are enriched within Link Generation Service 10.
cell_Id: once a message is linked to a call, cell id can be added if it is not present just relying on call context
message_direction: there are network messages that can go in both directions (sent/received) depending on the traced network element that generates it. Once the message is linked to the call, the algorithm is able to determine the real direction

### Flowcharts

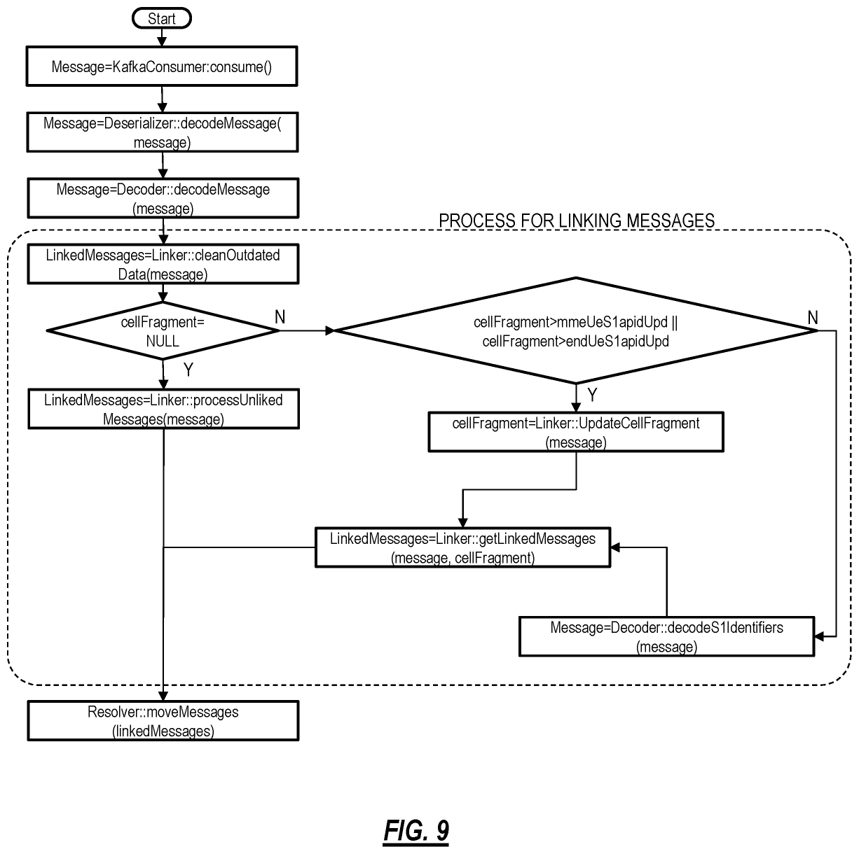

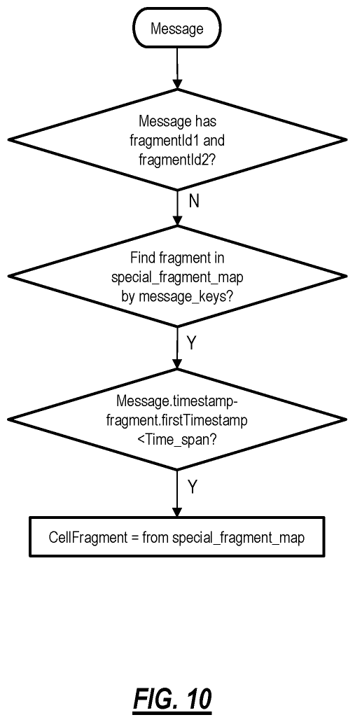

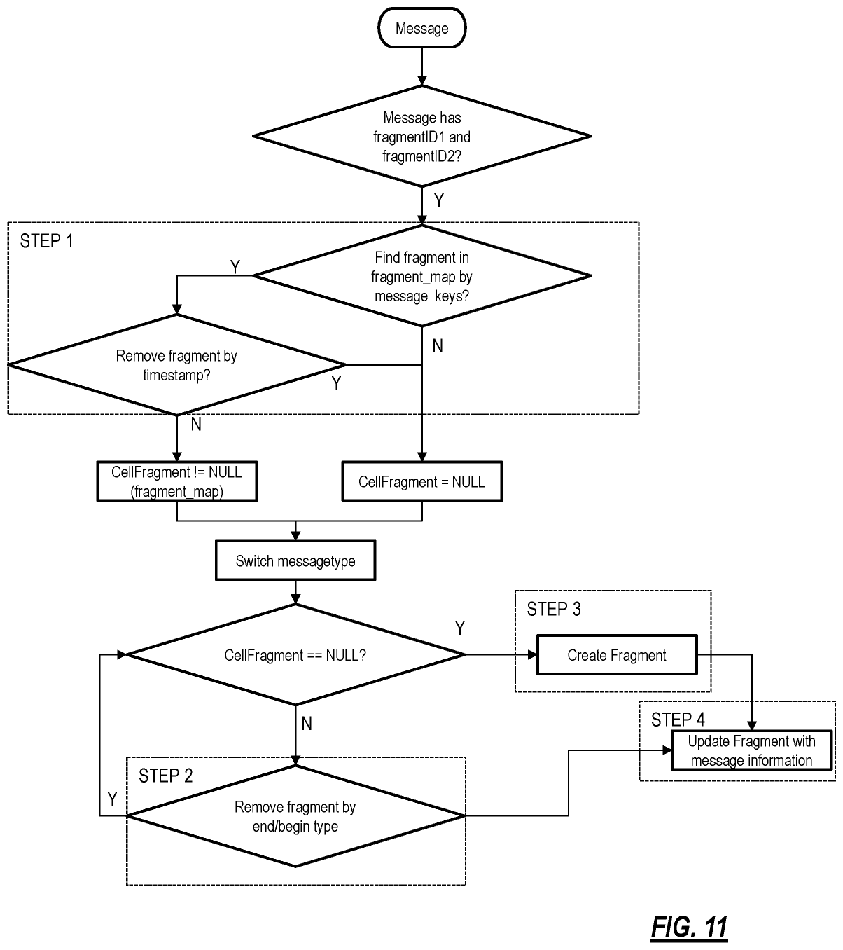

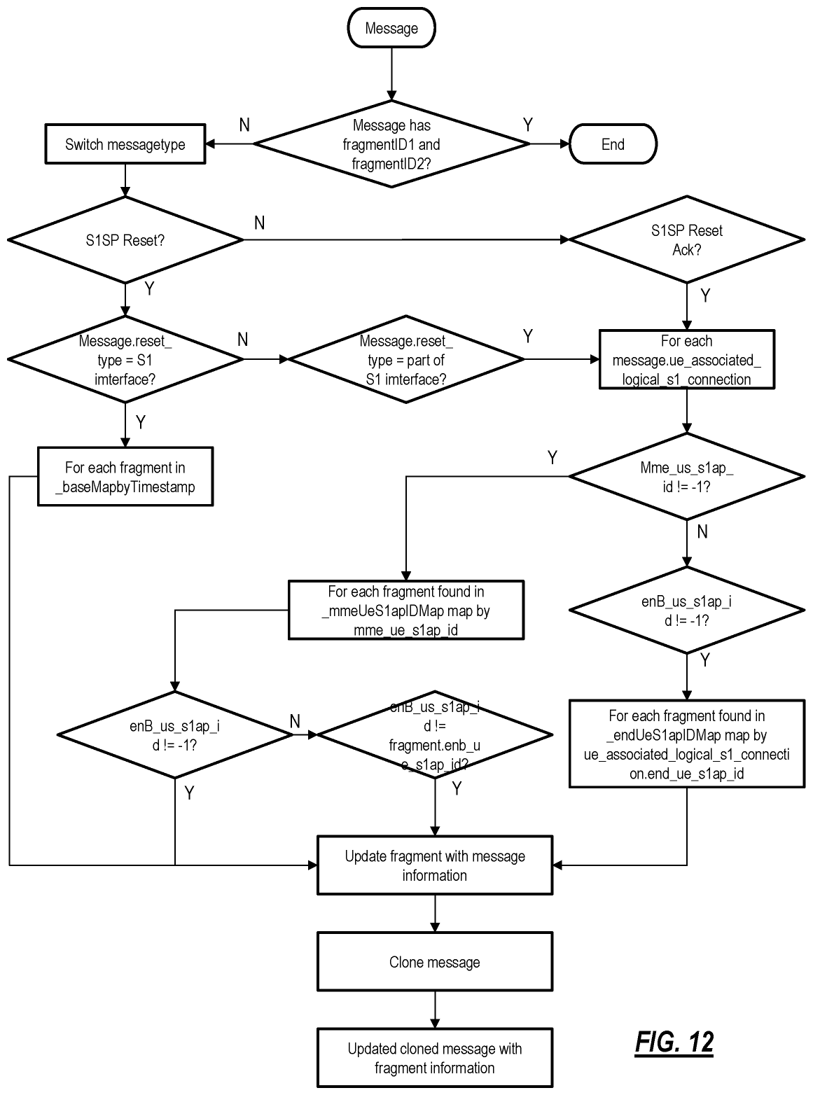

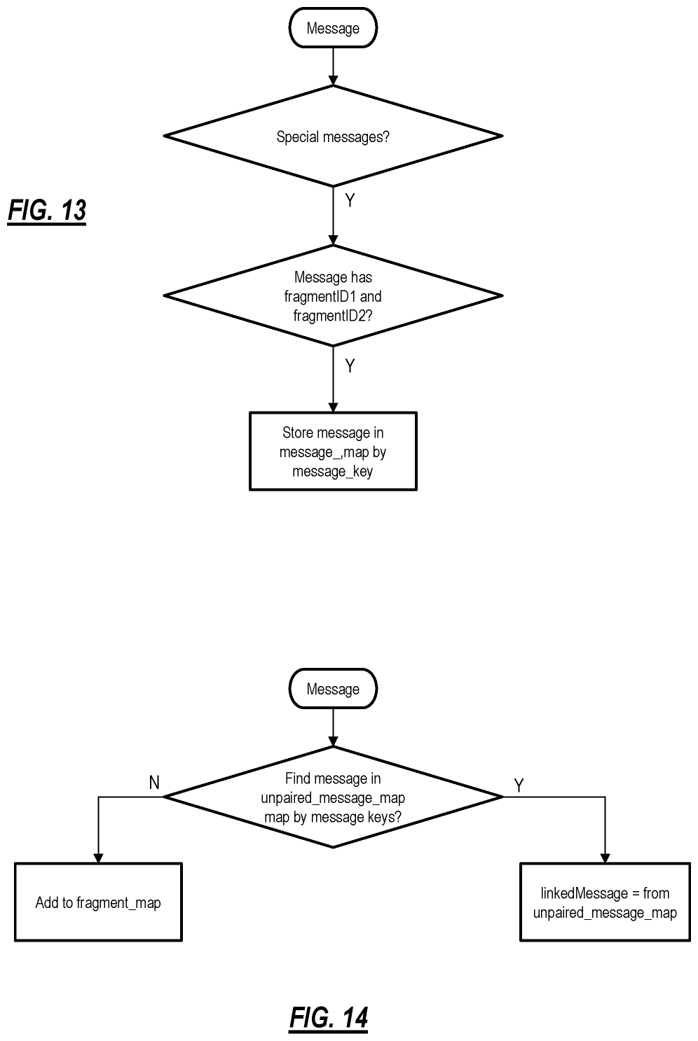

FIGS. 9-14 are flowcharts of various processes associated with the Link Generation Service. FIG. 9 is a Link Generation Service process. FIG. 10 illustrates how to link messages without fragmentID1 and fragmentID2 to a fragment. FIG. 11 illustrates how to link messages with the fragmentID1 and the fragmentID2 to a fragment. FIG. 12 illustrates how to process S1AP Reset messages. FIG. 13 illustrates how to store unlinked messages as EUTRA-RRC RRC Connection Request messages. FIG. 14 illustrates how to retrieve unlinked messages.

In FIG. 9, the Link Generation Service process is generalized to illustrate how the Link Generation Service 10 links the message to a cell fragment identifier.

The basic steps are:
1. Get cell fragment: link the message to the cell fragment.
2. Process unlinked messages: process special messages that were not able to obtain a cell fragment, i.e., messages without the FragmentID1 or FragmentID2
3. Update cell fragment: update cell fragment information with message information and update some maps used to link special messages
4. Get linked messages: try to retrieve special messages stored in step 2

### Get Cell Fragment

There are two different scenarios depending on if the message has fragment1 and fragmentId2 parameters:
a. Messages without fragmentId1 and fragmentId2
b. Messages with fragmentId1 and fragmentId2
Scenario 1: Messages without fragmentId1 or fragmentId2—Each type of special message tries to retrieve the fragment by searching in a specific map and with specific keys depending on the message type. There are also time considerations to decide if the fragment with the same keys is the right one. Again, FIG. 10 illustrates how to link messages without fragmentID1 and fragmentID2 to a fragment. Table 2 shows the map, the keys and the temporary condition for each type of message:

TABLE 2
Get cell fragments without fragment identifiers messages details

| Message | Fragment map | Message keys | Time span | |
|---|---|---|---|---|
| EUTRA-RRC RRC | _rrcConnRequestMap | CRNTI, Cell Id, Initial | 30 | seconds |
| Connection | | UE Identity, | | |
| Request | | Establishment Cause | | |
| EUTRA-RRC RRC | _reEstabRequestByFragmentId2Map | Cell Id, fragment Id 2 | 350 | milliseconds |
| Connection | | | | |
| Reestablishment | | | | |
| Request¹ | | | | |
| EUTRA-RRC RRC | _reEstabRequestByCrntiMap | Cell Id, crnti | 350 | milliseconds |
| Connection | | | | |
| Reestablishment | | | | |
| Request¹ | | | | |
| X2AP Handover | _x2HoReqMap | Cell Id, Old UE X2AP | 30 | seconds |
| Request | | Id | | |
| S1AP Handover | _s1HoReqMap | Cell Id, MME UE | 30 | seconds |
| Request | | S1AP Id | | |
| X2AP Handover | _x2HoReportMap | Source cell ECGI, | 30 | seconds |
| Report | | Failure cell ECGI | | |
| X2AP RLF | _x2RIfIndicationMap | Reestablishment cell | 30 | seconds |
| Indication | | ECGI, CRNTI | | |
| EUTRA-RRC RRC | _rrcConnRequestMapNb | CRNTI, Cell Id | 30 | seconds |
| Connection | | | | |
| Request-NB | | | | |

Note 1: EUTRA-RRC Connection Reestablishment Request will search in two different maps depending on having fragmentId2 parameter or not. Also, in the key of every map we have to add: message.technology, message.vendor, message.mcc, message.mnc,
Scenario 2: Messages with fragmentId1 and fragmentId2—These messages try to find an already created fragment, in case they do not find it, they will create one. Again, FIG. 11 illustrates how to link messages with the fragmentID1 and the fragmentID2 to a fragment. The several steps are marked in the FIG. 11 to show the decision algorithm:
Step 1: In this case, cell fragment is always searched in a map where the keys are fragmentId1 and fragmentId2. In case cell fragment is found, there are time considerations to remove the found fragment or not. The fragment will be removed in two example cases:
if the difference between message timestamp and the last linked message timestamp is higher than 7 minutes
If the fragment has a valid end type value and the difference between message timestamp and the last linked message timestamp is higher than 30 seconds

Removing a fragment implies:
1. Creating an End message and link it to the fragment
2. Removing the fragment from all maps where it is stored
Step 2: depending on the message type, check if the fragment obtained in step 1 is correct or it should be removed. Conditions to remove a fragment:
Fragment established and with a valid end type value
Fragment established with a begin type different from the one obtained by the message type
Table 3 shows the fragment begin type depending on message type:

TABLE 3
Begin type vs message type

| Begin Type | Message |
|---|---|
| RRC Establishment | EUTRA-RRC RRC Connection Request |
| | EUTRA-RRC RRC Connection Setup |
| | EUTRA-RRC RRC Connection Reject |
| | EUTRA-RRC RRC Connection Setup Complete |
| | EUTRA-RRC RRC Connection Request - NB |
| | EUTRA-RRC RRC Connection Setup - NB |
| | EUTRA-RRC RRC Connection Reject - NB |
| | EUTRA-RRC RRC Connection Setup Complete - |
| | NB |
| | EUTRA-RRC RRC Resume Request - NB |
| | EUTRA-RRC RRC Resume - NB |
| | EUTRA-RRC RRC Resume Complete - NB |
| | NR-RRC Setup Request |
| | NR-RRC Setup |
| | NR-RRC Reject |
| | NR-RRC Setup Complete |
| | NR-RRC Resume Request |
| | NR-RRC Resume |
| | NR-RRC Resume Complete |
| | ProcRrcConnSetup |
| | S1AP Initial UE Message |
| | NGAP Initial UE Message |
| RRC Reestablishment | EUTRA-RRC RRC Connection Reestablishment |
| | Request |
| | EUTRA-RRC RRC Connection Reestablishment |
| | EUTRA-RRC RRC Connection Reestablishment |
| | Failure |
| | EUTRA-RRC RRC Connection Reestablishment |
| | Complete |
| | EUTRA-RRC RRC Connection Reestablishment |
| | Request - NB |
| | EUTRA-RRC RRC Connection Reestablishment - |
| | NB |
| | EUTRA-RRC RRC Connection Reestablishment |
| | Failure - NB |
| | EUTRA-RRC RRC Connection Reestablishment |
| | Complete - NB |
| | NR-RRC Reestablishment Request |
| | NR-RRC Reestablshment |
| | NR-RRC Reestablishment Complete |
| | ProcRrcConnectionReestablishment |
| X2AP Handover | X2AP Handover Request |
| (only messages from target eNB) | X2AP Handover Request Acknowledge |
| | X2AP Handover Cancel |
| | X2AP Handover Preparation Failure |
| | XNAP Handover Request |
| | XNAP Handover Request Acknowledge |
| | XNAP Handover Cancel |
| | XNAP Handover Preparation Failure |
| S1AP Handover | S1AP Handover Request |
| | S1AP Handover Request Acknowledge |
| | S1AP Handover Failure |
| | NGAP Handover Request |
| | NGAP Handover Request Acknowledge |
| | NGAP Handover Failure |
| RRC Handover | EUTRA-RRC Connection Reconfiguration |
| | Complete |
| ENDC * | X2AP SgNB Addition Request |
| | X2AP SgNB Addition Request Acknowledge |
| | X2AP SgNB Modification Required |
| | X2AP SgNB Modification Confirm |
| | X2AP SgNB Release Request |
| | X2AP SgNB Release Request Acknowledge |
| | X2AP SgNB Release Required |
| | X2AP SgNB Release Confirm |
| | X2AP SgNB Modification Request |
| | X2AP SgNB Modification Request Acknowledge |
| | X2AP SgNB Change Required |
| | X2AP SgNB Change Confirm |
| | X2AP SgNB Reconfiguration Complete |
| Other | Other messages |

* Note:
There are some messages that do not perform this step:
RRC Reestablishment messages only perform this step if fragment begin type is “Other”.
EUTRA-RRC RRC Connection Reconfiguration Complete and EUTRA-RRC Connection Reconfiguration
X2AP message when they come from the source eNB

Step 3: Messages listed in Table 3 create a fragment if they are not already linked to one in the previous steps. Creating a fragment means a) add the fragment in _indexMapByTraceIdentifierKey map (this map is the one that is used in this scenario) and b) update some parameters with the information of the message that triggers the creation: fragmentId1, fragmentId2, firstTimestamp, lastTimestamp, beginType, enbId, technology, cellId. If the beginType is “Other”, the fragment is also set as “Established”.

Special cases: Although EUTRA-RRC RRC Connection Reconfiguration Complete and EUTRA-RRC RRC Connection Reconfiguration messages have valid fragmentId1 and fragmentId2, before creating a new fragment they will try to find the fragment as in Scenario 1 (EUTRA-RRC RRC Connection Reconfiguration will only do it if it contains Mobility Control Info parameter). In this case the parameters are:
Fragment map: _eutraRrcRrcConnReconfMap
Message keys: cellId and fragmentId2
Time span: 30 seconds

If the fragment found has beginType different from ENDC, this search is considered invalid, and a cell fragment is created.
Step 4: update fragment with message information. All messages linked to the fragment will update: lastTimestamp and lastMessage parameters. Additionally, depending on the message different information will be updated:

TABLE 4
Begin type vs message type

| Message | Updated parameter |
|---|---|
| EUTRA-RRC RRC Connection Request | crnti |
| EUTRA-RRC RRC Connection Setup | crnti |
| EUTRA-RRC RRC Connection Reject | crnti |
| EUTRA-RRC RRC Connection Setup | crnti |
| Complete | Established |
| EUTRA-RRC RRC Connection Request- | crnti |
| NB | |
| EUTRA-RRC RRC Connection Setup-NB | crnti |
| EUTRA-RRC RRC Connection Reject-NB | crnti |
| EUTRA-RRC RRC Connection Setup | crnti |
| Complete-NB | Established |
| NR-RRC Setup Request | crnti |
| NR-RRC Setup | crnti |
| NR-RRC Reject | crnti |
| NR-RRC Setup Complete | crnti |
| NR-RRC Resume Request | crnti |
| NR-RRC Resume | crnti |
| NR-RRC Resume Complete | crnti |
| ProcRrcConnectionReestablishment | endType, if last message in the fragment |
| | is EUTRA-RRC RRC Reestablishment |
| | Reject |
| EUTRA-RRC Connection Reconfiguration | Established if begin type = |
| Complete | RrcReconfiguration |
| S1AP Handover Notify | Established if begin type = S1apHo |
| NGAP Handover Notify | Established if begin type = S1apHo |
| EUTRA-RRC RRC Connection Release | Endtype = RRC |
| NR-RRC RRC Release | Endtype = RRC |
| S1AP UE Context Release Complete | Endtype = S1apHo |
| NGAP UE Context Release Complete | Endtype = S1apHo |
| XNAP UE Context Release(source gNB) | Endtype = X2apHo |
| XNAP UE Context Release(target gNB) | Established if begin type = X2apHo |
| X2AP SgNB Addition Request | Established if begin type = ENDC and |
| | technology = LTE and the fragment was |
| | created by this message |
| X2AP SgNB Addition Request | Established if begin type = ENDC and |
| Acknowledge | technology = LTE and the fragment was |
| | created by this message |
| X2AP SgNB Modification Required | Established if begin type = ENDC and |
| | technology = LTE and the fragment was |
| | created by this message |
| X2AP SgNB Modification Confirm | Established if begin type = ENDC and |
| | technology = LTE and the fragment was |
| | created by this message |
| X2AP SgNB Release Request | Established if begin type = ENDC and |
| | technology = LTE and the fragment was |
| | created by this message |
| X2AP SgNB Release Request | Established if begin type = ENDC and |
| Acknowledge | technology = LTE and the fragment was |
| | created by this message |
| X2AP SgNB Release Required | Established if begin type = ENDC and |
| | technology = LTE and the fragment was |
| | created by this message |
| X2AP SgNB Release Confirm | Established if begin type = ENDC and |
| | technology = LTE and the fragment was |
| | created by this message |
| X2AP SgNB Modification Request | Established if begin type = ENDC and |
| | technology = LTE and the fragment was |
| | created by this message |
| X2AP SgNB Modification Request | Established if begin type = ENDC and |
| Acknowledge | technology = LTE and the fragment was |
| | created by this message |
| X2AP SgNB Change Required | Established if begin type = ENDC and |
| | technology = LTE and the fragment was |
| | created by this message |
| X2AP SgNB Change Confirm | Established if begin type = ENDC and |
| | technology = LTE and the fragment was |
| | created by this message |
| X2AP SgNB Reconfiguration Complete | Established if begin type = ENDC and |
| | technology = LTE and the fragment was |
| | created by this message |

X2AP UE Context Release message is a special one due to being used for different standard procedures: handover and ENDC procedures. When the message does not include SgNB UE X2AP Id parameter, if it is traced in the source eNB, it will set endType=X2apHo, else if the begin type is X2apHo then it will set the fragment to “Established”. When the message includes SgNB UE X2AP Id parameter, if the fragment technology is NR, then it will set endType=ENDC.

Process unlinked messages—There are two different scenarios depending on the message type:
a. S1AP Reset, S1AP Reset Acknowledge, NGAP Reset and NGAP Reset Acknowledge that can be linked to several cell fragments
b. Other special messages that will be stored
Scenario 1: S1AP/NGAP Reset and S1AP/NGAP Reset Acknowledge—S1AP/NGAP Reset and S1AP/NGAP Reset Acknowledge messages will find every fragment that they can be linked to. In case of the S1AP/NGAP Reset, depending on Reset Type parameter it can be linked to all the opened fragments in the Link Generator Serving belonging to the same Enb or to a list of them identified in the UE Associated Logical S1 Connection List parameter. In the case of the S1AP/NGAP Reset Acknowledge the second option is the only one available. Again, FIG. 12 illustrates how to process S1AP/NGAP Reset messages. As shown in FIG. 12, for each fragment found there are 3 steps:
(1) Update fragment with message information: the parameters updated in the fragment are:
   lastTimestamp: message timestamp
   lastMessage: message type
   endType: RESET
(2) Clone message: as the message can be linked to several fragments, we have to clone the message as many times as fragments to link.
(3) Update cloned message with fragment information: the parameters updated in the message are:
   cellFragmentIdentifier: fragment cellFragmentIdentifier
   source: fragment source
   index: fragment message index
   cell id: fragment cell id
Scenario 2: Other special messages—If the message has not been linked in the step 1 and does not have fragmentId1 or fragmentId2 and is one of an RRC Connection Request, RRC Connection Request-NB, X2AP Handover Request, S1AP Handover Request, RRC Connection Reestablishment Request, X2AP Handover Report, X2AP RLF Indication, S1AP Reset, S1AP Reset Acknowledge, etc., store it in a specific map to try to link the message later. Again, FIG. 13 illustrates how to store unlinked EUTRA-RRC RRC Connection Request messages.

Each message type will be stored in a different map with a different key parameter. The following table shows the map and the keys for each type of message:

TABLE 5
Stored messages without fragment identifiers

| Message | Fragment map | Message keys |
|---|---|---|
| EUTRA-RRC | _unpairedRrcConnRequestMessages | CRNTI, Cell Id, Initial |
| RRC Connection | | UE Identity, |
| Request | | Establishment Cause |
| EUTRA-RRC | _unpairedReEstabByFragmentId2Messages | Cell Id, fragment Id 2 |
| RRC Connection | | |
| Reestablishment | | |
| Request¹ | | |
| EUTRA-RRC | _unpairedReEstabByCrntiMessages | Cell Id, crnti |
| RRC Connection | | |
| Reestablishment | | |
| Request¹ | | |
| X2AP Handover | _unpairedX2HoReqMessages | Cell Id, Old UE X2AP |
| Request | | Id |
| S1AP Handover | _unpairedS1HoReqMessages | Cell Id, MME UE |
| Request | | S1AP Id |
| X2AP Handover | _unpairedX2HoReportMessages | Source cell ECGI, |
| Report | | Failure cell ECGI |
| X2AP RLF | _unpairedX2RIfIndicationMessages | Reestablishment cell |
| Indication | | ECGI, CRNTI |
| EUTRA-RRC | _unpairedRrcConnRequestMessagesNB | CRNTI, Cell Id |
| RRC Connection | | |
| Request-NB | | |

Note 1—EUTRA-RRC Connection Reestablishment Request will search in two different maps depending on having fragmentId2 parameter or not. Also, in the key of every map we have to add: message.technology, message.vendor, message.mcc, message.mnc,
Update cell fragment—If the fragment has not set mmeUeS1ap parameter and message contains it, the message will update the parameter and the fragment will be added to the _mmeUeS1apIdMap map. If the fragment has not set enbUeS1ap parameter and message contains it, the message will update the parameter and the fragment will be added to the _enbUeS1apIdMap map. If the fragment has not been already added to the _eutraRrcRrcConnReconfMap, it will be added.

Get linked messages—When a message has been linked to a fragment the latest step is to try to retrieve unlinked messages that have been stored in the processing of unlinked message with the fragment and the message information. For each unlinked message type there are one or several messages that try to retrieve it. The unlinked message will be searched in a specific map and with specific keys depending on the message type. There are also time considerations to decide if the fragment with the same keys is the right one.

In case the unlinked message is not found, the fragment will be added to the corresponding map. Again, FIG. 14 illustrates how to retrieve unlinked messages.

Table 6 shows the map to search, the keys and the temporary condition for each message type. Note that the relation between the map and the unlinked message is registered in Table 5

TABLE 2
Retrieving unlinked messages information

| | | Message | | |
|---|---|---|---|---|
| Message | Messages map | keys | Time span | |
| ProcRrcConnSetup | _unpairedRrcConnRequestMessages | CRNTI, Cell | 30 | seconds |
| | | Id, Initial UE | | |
| | | Identity, | | |
| | | Establishment | | |
| | | Cause | | |
| ProcRrcConnSetup | _unpairedRrcConnRequestNbMessages | CRNTI, Cell | 30 | seconds |
| | | Id | | |
| EUTRA-RRC | _unpairedReEstabByCrntiMessages | Cell Id, crnti | 350 | milliseconds |
| Connection | | | | |
| Reestablishment ¹ | | | | |
| EUTRA-RRC | _unpairedReEstabByFragmentId2Messages | Cell Id, | 350 | milliseconds |
| Connection | | fragment Id | | |
| Reestablishment ¹ | | 2 | | |
| X2AP Handover | _unpairedX2RIfIndicationMessages | Target Cell | 30 | seconds |
| Request | | Id, CRNTI | | |
| X2AP Handover | _unpairedX2HoReportMessages | Last Visited | 30 | seconds |
| Request | | Cell Id, | | |
| | | Target Cell | | |
| | | Id | | |
| X2AP Handover | _unpairedX2HoReqMessages | Cell Id, Old | 30 | seconds |
| Request | | UE X2AP Id | | |
| Acknowledge^{2,3} | | | | |
| X2AP Handover | _unpairedX2HoReqMessages | Cell Id, Old | 30 | seconds |
| Preparation | | UE X2AP Id | | |
| Failure^{2,3} | | | | |
| X2AP Handover | _unpairedX2HoReqMessages | Cell Id, Old | 30 | seconds |
| Cancel^{2,3} | | UE X2AP Id | | |
| S1AP Handover | _unpairedS1HoReqMessages | Cell Id, | 30 | seconds |
| Request | | MME UE | | |
| Acknowledge | | S1AP Id | | |
| S1AP Handover | _unpairedS1HoReqMessages | Cell Id, | 30 | seconds |
| Failure | | MME UE | | |
| | | S1AP Id | | |

Note
¹ EUTRA-RRC Connection Reestablishment Request will search in two different maps first in the _unpairedReEstabByCrntiMessages and in case message is not found in unpairedReEstabByFragmentId2Messages.
Note
²Only messages traced in the target eNB
Note
³In case Handover Request is retrieve, use Handover Request as an input of the algorithm. Also, in the key of every map we have to add: message.technology, message.vendor, message.mcc, message.mnc,

Table 7 shows the relation between message type and map where fragment is stored in case unlinked message is not found:

TABLE 7
Cell fragment maps

| Message | Messages map | Message keys |
|---|---|---|
| ProcRrcConnSetup | _rrcConnRequestMap | CRNTI, Cell Id, Initial |
| | | UE Identity, |
| | | Establishment Cause |
| ProcRrcConnSetup | _rrcConnRequestNbMap | CRNTI, Cell Id |
| EUTRA-RRC | _reEstabRequestByCrntiMap | Cell Id, crnti |
| Connection | | |
| Reestablishment | | |
| EUTRA-RRC | _reEstabRequestByFragmentId2Map | Cell Id, fragment Id 2 |
| Connection | | |
| Reestablishment | | |
| X2AP Handover | _x2RIfIndicationMap | Target Cell Id, CRNTI |
| Request | | |
| X2AP Handover | _x2HoReportMap | Last Visited Cell Id, |
| Request | | Target Cell Id |
| X2AP Handover | _x2HoReqMap | Cell Id, Old UE X2AP Id |
| Request | | |
| Acknowledge^{2,3} | | |
| X2AP Handover | _x2HoReqMap | Cell Id, Old UE X2AP Id |
| Preparation Failure^{2,3} | | |
| X2AP Handover | _x2HoReqMap | Cell Id, Old UE X2AP Id |
| Cancel^{2,3} | | |
| S1AP Handover | _s1HoReqMap | Cell Id, MME UE S1AP |
| Request | | Id |
| Acknowledge | | |
| S1AP Handover | _s1HoReqMap | Cell Id, MME UE S1AP |
| Failure | | Id |

Note
²Only messages traced in the target eNB
Note
³In case Handover Request is retrieve, use Handover Request as an input of the algorithm. Also, in the key of every map we have to add: message.technology, message.vendor, message.mcc, message.mnc,

The retrieved messages will be updated with the fragment information. The parameters updated with the fragment information are: cellFragmentIdentifier, source, index and cellId.

The output of the Link Generation Service 10 allows the distribution of the messages between all the elements in the pipeline guaranteeing that all messages belonging to the same call are processed by the same kind of service.

Output format of Link Generation service is described as follows:

TABLE 8
Output of Link Generation Service

| Field | Type | Description |
|---|---|---|
| timestamp_utc_ms | int64 | Timestamp of the message in milliseconds |
| time_zone_correction | int32 | Time zone correction |
| timestamp_dst_cor | int32 | Day Light Save Time Correction |
| technology | int32 | Technology |
| vendor | int32 | Vendor |
| version | int32 | Version |
| mcc | string | Mobile Country Code of the subscriber network |
| | | (3 digits) |
| mnc | string | Mobile Network Code of the subscriber network |
| | | (2/3 dig) |
| fragment_id_1 | int64 | First Identifier of the Unique Session Id for the UE |
| fragment_id_2 | int64 | Second Identifier of the Unique Session Id for the UE |
| enb_id | int64 | eNode B Id or gNode B Id depending on technology |
| cell_id | int32 | Cell Id |
| core_ue_id | int64 | mme_ue_s1ap_id or amf_ue_ngap_id depending on |
| | | the technology. Uniquely identifies the UE |
| | | association over the S1 interface within the MME or |
| | | NG interface within the AMF |
| ran_ue_id | int64 | enb_ue_s1ap_id or ran_ue_ngap_id depending on |
| | | the technology. Uniquely identifies the UE |
| | | association over the S1 interface within a eNB or NG |
| | | interface within an gNB |
| gummei | int64 | gummei or guami depending on the technology. |
| | | Unique identifier of a MME or an AMF |
| c_rnti | int32 | C-RNTI Identifier |
| message_type | int32 | enumerated to identify the same message from |
| | | different vendors |
| message_direction | int32 | Message direction: sent, received |
| message_content | bytes | asn.1 content for 3GPP messages, raw data for |
| | | messages |
| cell_fragment_identifier | int64 | Unique Identifier to link message to a cell Fragment |
| | | Identifier. 2 pod ID, 6 auto incremental |
| | | (starting from 0) |
| message_index | int64 | Message index inside of the cell fragment |
| ne_source_type | int32 | Source network element type |
| ne_source_identifiers | int64 | Source network element internal unique identifier |
| ne_target_type | int32 | Target network element type |
| ne_target_identifiers | int64 | Target network element internal unique identifier |
| imsi | string | International Mobile Subscriber Identity |
| ue_mcc | string | Mobile Country Code of the Home Public Land |
| | | Mobile Network |
| ue_mnc | string | Mobile Network Code of the Home Public Land |
| | | Mobile Network |
| imei | string | International Mobile Equipment Identity |
| svn | string | Handset Software Version |
| handset_tac | string | Type Allocation Code of the subscriber handset |
| source_identifier | int32 | Source identifier with edge information to allow edge |
| | | distribution. 1 edge, 3 pod ID |
| gnodeb_id_length | int32 | Number of bits used to encode gNodeB Id |

### Process

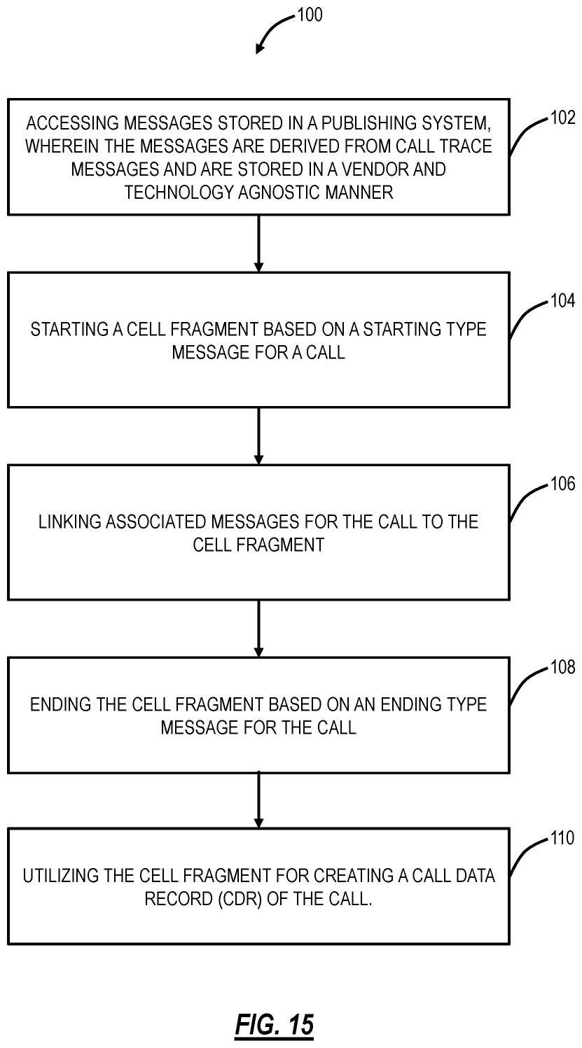

FIG. 15 is a flowchart of a process 100 for link generation for a Radio Access Network (RAN) parser that links messages from different interfaces into cell fragments. The process 100 contemplates implementation as a method having steps, via a processing device configured to implement the steps, via a cloud service configured to implement the steps, and/or as non-transitory computer-readable medium with instructions that, when executed, cause one or more processors to implement the steps.

The process 100 includes accessing messages stored in a publishing system, wherein the messages are derived from Call Trace messages and are stored in a vendor and technology agnostic manner (step 102); starting a cell fragment based on a starting type message for a call (step 104); linking associated messages for the call to the cell fragment (step 106); ending the cell fragment based on an ending type message for the call (step 108); and utilizing the cell fragment for creating a Call Data Record (CDR) of the call (step 110). The publishing system is configured to receive the messages at an edge of a mobile network.

The linking can be based on fragment identifiers in the messages. The linking for messages that do not have the fragment identifiers can be based on using standard fields from other messages already linked in the cell fragment. The other messages can be any of an RRC Connection Request, RRC Connection Request-NB, X2AP Handover Request, S1AP Handover Request, RRC Connection Reestablishment Request, X2AP Handover Report, X2AP RLF Indication, S1AP Reset, S1AP Reset Acknowledge, NGAP Reset and NGAP Reset Acknowledge. The process 100 can further include enriching the cell fragment with user identities for the call. The user identities can include one or more of International Mobile Subscriber Identity (IMSI) and International Mobile Equipment Identity (IMEI). The call can be in one of three different states including started, established, and ended, and wherein the linking is based on which state the call is in.

### Processing System

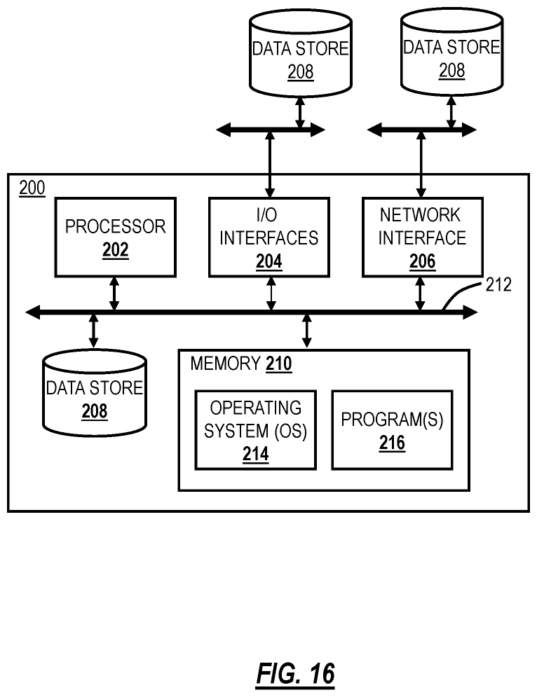

FIG. 16 is a block diagram of a processing system 200, which may be used to implement the process 100. The processing system 200 may be a digital computer that, in terms of hardware architecture, generally includes a processor 202, input/output (I/O) interfaces 204, a network interface 206, a data store 208, and memory 210. It should be appreciated by those of ordinary skill in the art that FIG. 16 depicts the processing system 200 in an oversimplified manner, and a practical embodiment may include additional components and suitably configured processing logic to support known or conventional operating features that are not described in detail herein. The components (202, 204, 206, 208, and 210) are communicatively coupled via a local interface 212. The local interface 212 may be, for example, but not limited to, one or more buses or other wired or wireless connections, as is known in the art. The local interface 212 may have additional elements, which are omitted for simplicity, such as controllers, buffers (caches), drivers, repeaters, and receivers, among many others, to enable communications. Further, the local interface 212 may include address, control, and/or data connections to enable appropriate communications among the aforementioned components.

The processor 202 is a hardware device for executing software instructions. The processor 202 may be any custom made or commercially available processor, a Central Processing Unit (CPU), an auxiliary processor among several processors associated with the processing system 200, a semiconductor-based microprocessor (in the form of a microchip or chipset), or generally any device for executing software instructions. When the processing system 200 is in operation, the processor 202 is configured to execute software stored within the memory 210, to communicate data to and from the memory 210, and to generally control operations of the processing system 200 pursuant to the software instructions. The I/O interfaces 204 may be used to receive user input from and/or for providing system output to one or more devices or components.

The network interface 206 may be used to enable the processing system 200 to communicate on a network, such as the Internet 104. The network interface 206 may include, for example, an Ethernet card or adapter or a Wireless Local Area Network (WLAN) card or adapter. The network interface 206 may include address, control, and/or data connections to enable appropriate communications on the network. A data store 208 may be used to store data. The data store 208 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof.

Moreover, the data store 208 may incorporate electronic, magnetic, optical, and/or other types of storage media. In one example, the data store 208 may be located internal to the processing system 200, such as, for example, an internal hard drive connected to the local interface 212 in the processing system 200. Additionally, in another embodiment, the data store 208 may be located external to the processing system 200 such as, for example, an external hard drive connected to the I/O interfaces 204 (e.g., SCSI or USB connection). In a further embodiment, the data store 208 may be connected to the processing system 200 through a network, such as, for example, a network-attached file server.

The memory 210 may include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 210 may incorporate electronic, magnetic, optical, and/or other types of storage media. Note that the memory 210 may have a distributed architecture, where various components are situated remotely from one another but can be accessed by the processor 202. The software in memory 210 may include one or more software programs, each of which includes an ordered listing of executable instructions for implementing logical functions. The software in the memory 210 includes a suitable Operating System (O/S) 214 and one or more programs 216. The operating system 214 essentially controls the execution of other computer programs, such as the one or more programs 216, and provides scheduling, input-output control, file and data management, memory management, and communication control and related services. The one or more programs 216 may be configured to implement the various processes, algorithms, methods, techniques, etc. described herein.

In an embodiment, one or more processing devices 200 can be configured in a cluster and/or in a cloud system, for implementing the process 100. Cloud computing systems and methods abstract away physical servers, storage, networking, etc., and instead offer these as on-demand and elastic resources. The National Institute of Standards and Technology (NIST) provides a concise and specific definition which states cloud computing is a model for enabling convenient, on-demand network access to a shared pool of configurable computing resources (e.g., networks, servers, storage, applications, and services) that can be rapidly provisioned and released with minimal management effort or service provider interaction. Cloud computing differs from the classic client-server model by providing applications from a server that are executed and managed by a client's web browser or the like, with no installed client version of an application required. The phrase “Software as a Service” (SaaS) is sometimes used to describe application programs offered through cloud computing. A common shorthand for a provided cloud computing service (or even an aggregation of all existing cloud services) is “the cloud.”

### CONCLUSION

It will be appreciated that some embodiments described herein may include one or more generic or specialized processors (“one or more processors”) such as microprocessors; central processing units (CPUs); digital signal processors (DSPs): customized processors such as network processors (NPs) or network processing units (NPUs), graphics processing units (GPUs), or the like; field programmable gate arrays (FPGAs); and the like along with unique stored program instructions (including both software and firmware) for control thereof to implement, in conjunction with certain non-processor circuits, some, most, or all of the functions of the methods and/or systems described herein. Alternatively, some or all functions may be implemented by a state machine that has no stored program instructions, or in one or more application-specific integrated circuits (ASICs), in which each function or some combinations of certain of the functions are implemented as custom logic or circuitry. Of course, a combination of the aforementioned approaches may be used. For some of the embodiments described herein, a corresponding device in hardware and optionally with software, firmware, and a combination thereof can be referred to as “circuitry configured or adapted to,” “logic configured or adapted to,” etc. perform a set of operations, steps, methods, processes, algorithms, functions, techniques, etc. on digital and/or analog signals as described herein for the various embodiments.

Moreover, some embodiments may include a non-transitory computer-readable storage medium having computer-readable code stored thereon for programming a computer, server, appliance, device, processor, circuit, etc. each of which may include a processor to perform functions as described and claimed herein. Examples of such computer-readable storage mediums include, but are not limited to, a hard disk, an optical storage device, a magnetic storage device, a read-only memory (ROM), a programmable read-only memory (PROM), an erasable programmable read-only memory (EPROM), an electrically erasable programmable read-only memory (EEPROM), Flash memory, and the like. When stored in the non-transitory computer-readable medium, software can include instructions executable by a processor or device (e.g., any type of programmable circuitry or logic) that, in response to such execution, cause a processor or the device to perform a set of operations, steps, methods, processes, algorithms, functions, techniques, etc. as described herein for the various embodiments.

Although the present disclosure has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present disclosure, are contemplated thereby, and are intended to be covered by the following claims. The foregoing sections include headers for various embodiments and those skilled in the art will appreciate these various embodiments may be used in combination with one another as well as individually.

What is claimed is:

1. A method comprising steps of:
accessing messages stored in a publishing system, wherein the messages are derived from Call Trace messages and are stored in a vendor and technology agnostic manner;
starting a cell fragment based on a starting type message for a call;
linking associated messages for the call to the cell fragment;
ending the cell fragment based on an ending type message for the call; and
utilizing the cell fragment for creating a Call Data Record (CDR) of the call.

2. The method of claim 1, wherein the publishing system is configured to receive the messages at an edge of a mobile network.

3. The method of claim 1, wherein the linking is based on fragment identifiers in the messages.

4. The method of claim 3, wherein the linking for messages that do not have the fragment identifiers is based on using standard fields from other messages already linked in the cell fragment.

5. The method of claim 4, wherein the other messages are any of an RRC Connection Request, RRC Connection Request-NB, X2AP Handover Request, S1AP Handover Request, RRC Connection Reestablishment Request, X2AP Handover Report, X2AP RLF Indication, S1AP Reset, and S1AP Reset Acknowledge.

6. The method of claim 1, wherein the steps further include:
enriching the cell fragment with user identities for the call.

7. The method of claim 6, wherein the user identities include one or more of International Mobile Subscriber Identity (IMSI) and International Mobile Equipment Identity (IMEI).

8. The method of claim 1, wherein the call is in one of three different states including started, established, and ended, and wherein the linking is based on which state the call is in.

9. A processing system comprising:
one or more processors; and
memory storing instructions for programming the one or more processors to access messages stored in a publishing system, wherein the messages are derived from Call Trace messages and are stored in a vendor and technology agnostic manner;
start a cell fragment based on a starting type message for a call;
link associated messages for the call to the cell fragment;
end the cell fragment based on an ending type message for the call; and
utilize the cell fragment for creating a Call Data Record (CDR) of the call.

10. The processing system of claim 9, wherein the publishing system is configured to receive the messages at an edge of a mobile network.

11. The processing system of claim 9, wherein the associated messages are linked based on fragment identifiers in the messages.

12. The processing system of claim 11, wherein the associated messages that do not have the fragment identifiers are linked based on using standard fields from other messages already linked in the cell fragment.

13. The processing system of claim 12, wherein the other messages are any of an RRC Connection Request, RRC Connection Request-NB, X2AP Handover Request, S1AP Handover Request, RRC Connection Reestablishment Request, X2AP Handover Report, X2AP RLF Indication, S1AP Reset, and S1AP Reset Acknowledge.

14. The processing system of claim 9, wherein the instructions further program the one or more processors to
enrich the cell fragment with user identities for the call.

15. The processing system of claim 14, wherein the user identities include one or more of International Mobile Subscriber Identity (IMSI) and International Mobile Equipment Identity (IMEI).

16. The processing system of claim 9, wherein the call is in one of three different states including started, established, and ended, and wherein the linking is based on which state the call is in.

17. A non-transitory computer-readable medium comprising instructions for programming one or more processors to perform steps of:
accessing messages stored in a publishing system, wherein the messages are derived from Call Trace messages and are stored in a vendor and technology agnostic manner;
starting a cell fragment based on a starting type message for a call;
linking associated messages for the call to the cell fragment;
ending the cell fragment based on an ending type message for the call; and
utilizing the cell fragment for creating a Call Data Record (CDR) of the call.

18. The non-transitory computer-readable medium of claim 17, wherein the publishing system is configured to receive the messages at an edge of a mobile network.

19. The non-transitory computer-readable medium of claim 17, wherein the linking is based on fragment identifiers in the messages.

20. The non-transitory computer-readable medium of claim 17, wherein the steps further include:
enriching the cell fragment with user identities for the call.
